(19) United States
(12) Patent Application Publication
(10) Pub. No.: US 2007/0102956 A1
(43) Pub. Date: May 10, 2007

(54) Snap fit pockets for anchoring a watershield

(76) Inventors: Matthew M. Bucholtz, Northfield Center, OH (US); Jeffrey A. Kral, North Royalton, OH (US)

Correspondence Address: FAY SHARPE LLP, 1100 SUPERIOR AVENUE, SEVENTH FLOOR, CLEVELAND, OH, 44114, US

(21) Appl. No.: 11/586,371

(22) Filed: Oct. 25, 2006

Related U.S. Application Data
(60) Provisional application No. 60/730,135, filed on Oct. 25, 2005.

(51) Int. Cl. B60J 5/00

(52) U.S. Cl. 296/146.7

(57) ABSTRACT

A watershield for use with a car door, having a wall; a pocket formed in and extending from the wall; an undercut formed on opposite ends of the pocket, wherein the pocket is conformed to be received by an opening in a metal portion of a vehicle door and snap fit the watershield to the vehicle door.

### CLAIM OF PRIORITY

This application claims priority from U.S. Provisional Application Ser. No. 60/730,135, filed on Oct. 25, 2005.

### BACKGROUND OF THE INVENTION

Current automotive door watershield constructions use adhesives, gaskets, or other mechanical fasteners to anchor the watersheild to the door. Furthermore, three-dimensional forming is used to accommodate door hardware, wiring, lock rods, crash bolsters, trim panel hooks, speakers, and the like. This forming is done by thermoforming, vacuum forming, cold forming, etc. Additionally, foam blocks can be used to apply pressure on the watershield for isolating vibration.

There is a need for anchoring a watershield to a car door without the need for adhesives, extra gaskets or intricate mechanical couplings.

Accordingly, there is a need for anchoring a watershield, which overcomes the above-mentioned deficiencies and others, while obtaining better and more advantageous results.

### SUMMARY OF THE INVENTION

The configuration of this invention, shown in FIG. 1, is the creation of an undercut 10 of a three-dimensional formed snap pocket 12 of a wall of watershield 14. The undercut has a smaller inside diameter than at least a portion of the areas adjacent thereto. This creates a generally mushroom or flared configuration as shown in FIG. 1. The undercut may be formed by a number of manufacturing techniques as generally well known in the industry. The snap fit pocket engages a hole in a metal sheet of a vehicle door and snaps or secures the watershield in place.

Other objects, features and advantages of the invention will become apparent to those skilled in the art from a study of the detailed descriptions of the preferred embodiments set forth herein and illustrated in the accompanying drawings.

### BRIEF DESCRIPTION OF THE DRAWINGS

Further aspects of the invention will become apparent by reference to the detailed description when considered in conjunction with the Figures, wherein like reference numbers indicate like elements through the several views, and wherein:

FIG. 1 is a side elevational view in cross section of a snap fit pocket in accordance with a preferred embodiment of the present invention;

FIG. 2A is a front view of a side of a car door with a hole for a snap fit pocket of FIG. 1;

FIG. 2B is a front view of a snap fit pocket of a watershield in accordance with a preferred embodiment of the present invention;

FIG. 2C is a side elevational view showing a snap fit pocket engaged in a hole in sheet metal of a car door in accordance with a preferred embodiment of the present invention;

FIG. 3A is a front and side elevational view illustrating an undercut pocket in accordance with a first embodiment of the present invention;

FIG. 3B is a front and side elevational view of an undercut pocket in accordance with a second embodiment of the present invention;

FIG. 3C is a front view of an undercut pocket in accordance with a third embodiment of the present invention;

FIG. 4 is a front and side elevational view of an undercut pocket with an insert in accordance with another embodiment of the invention;

FIG. 5 is a front and side elevational view of an undercut pocket with an attachment in accordance with another embodiment of the present invention;

FIG. 6 is a side elevational view of an undercut pocket with an insert therein; and

FIG. 7 is a side elevational view of an undercut pocket with an insert therein.

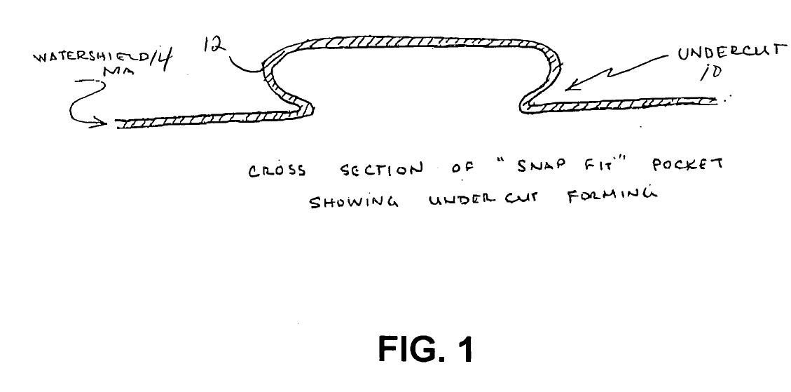

### DETAILED DESCRIPTION OF THE EMBODIMENTS

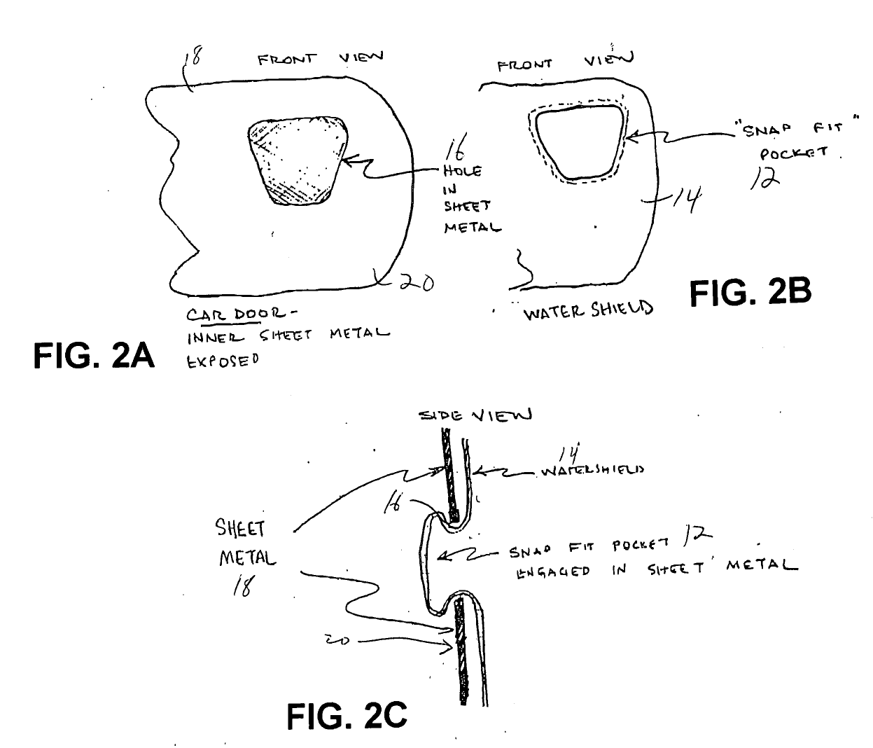

The invention facilitates several different applications and achieves a number of benefits. First, the shape of the pocket allows the pocket to be snapped into a similarly shaped hole or opening 16 in, for example, the sheet metal 18 of a car door or body cavity 20 in the manner shown in FIGS. 2A, 2B and 2C. This snap fit allows intimate contact of the three-dimensional pocket 12 of the shield 14 to sheet metal 18 of the car door cavity 20. This contact locates, holds, secures or simply puts pressure on the watershield and secures the shield to the car door. This, in turn, accomplishes one or more of the following results; namely, it allows easy correct location of the shield, retains a shield in place without the use of adhesives or other fasteners, minimizes or eliminates the interference of the watershield with a trim panel or any other interior components, minimizes or eliminates watershield “buzz” caused by vibration from the speaker or other source, reduces the amount of adhesive or other fastening system materials and directs and channels water toward the bottom of a door or other component.

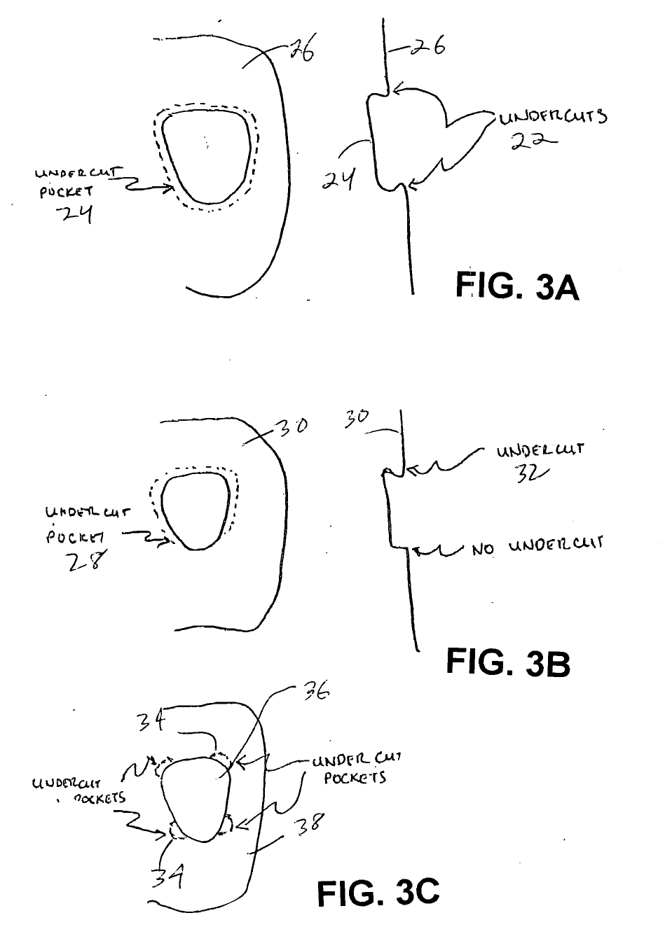

Referring to FIG. 3A, the general shape described above may take on numerous formations including an undercut 22 that would encompass the entire perimeter of the formed pocket 24 in the watershield 26. It could also take the form of a partial perimeter design as seen in FIG. 3B. Here, the pocket 28 of watershield 30 has an undercut 32 around a portion of the perimeter of the pocket. Still further, it could advantageously have an intermittent conformation, seen in FIG. 3C, where one or more undercuts 34 may be used to effect the conditions outlined above. The undercuts 34 are intermittently spaced around a perimeter of the pocket 36 of watershield 38.

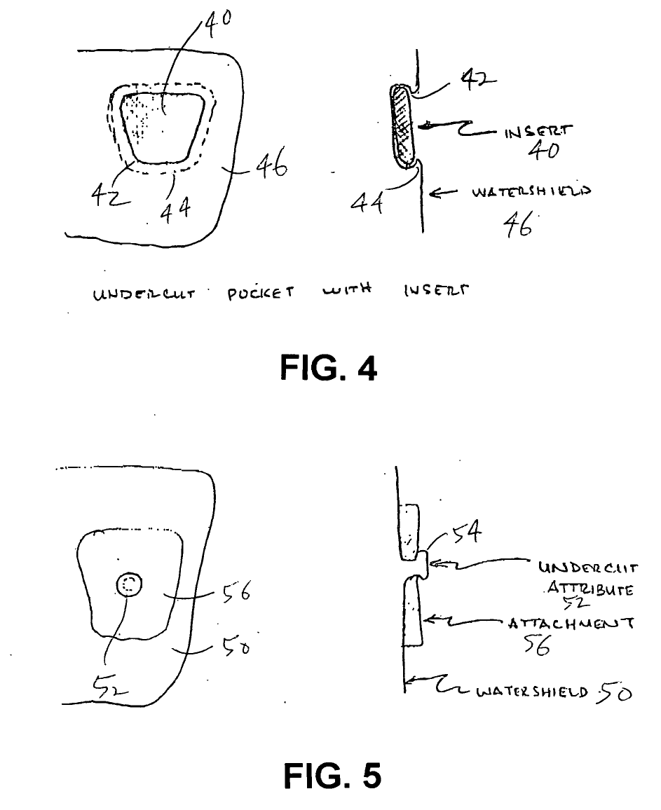

This under cut development may also be advantageously employed to hold acoustic materials, acoustic barriers, or other lightweight components to the watershield as demonstrated in FIG. 4. These components would include an insert 40 within a pocket 42 surrounded by undercut 44 within the watershield 46. Again, the complete perimeter partial perimeter, or intermittent formed attributes may be used to secure the materials as previously shown in FIGS. 3A-3C.

Securing these materials such as with a friction fit eliminates the need for more expensive types of attachments and supporting equipment, such as laminating, heat staking, heat sealing, sonic welding, adhesive coating, mechanical fasteners, etc. Unlike sonic welding, dissimilar materials could be used. Furthermore, since the materials are simply held in place by friction, the exchange of materials can be accomplished quite easily. This allows the watershield to be adjusted to provide the best sound performance based on the materials that are placed in the pocket.

Along a similar line, no material or less expensive material can be used on the low end cars, with higher performing materials being used on the high end cars. “Sound” packages can thus be offered as an option and installed on the car line, in a dealership, or even as an aftermarket add on. No tooling or special equipment is needed. Another considerable benefit resides in the fact that the materials are not mechanically joined together. This allows for easy separation of the materials and facilitates the recycling of the materials as is now being advanced in the so-called “green” car initiative.

An alternative arrangement contemplates the use of a similar attribute with an undercut. However, rather than hold the material and/or component by the outside edge, the undercut design corresponds to an interior hole, edge, or other attribute that could be secured in a similar friction fit. Such arrangement is shown in FIG. 5. Here, the shield 50 has an undercut 52 formed centrally with edges 54 to retain one or more attachments 56 in place and are formed through a central portion of the attachment(s).

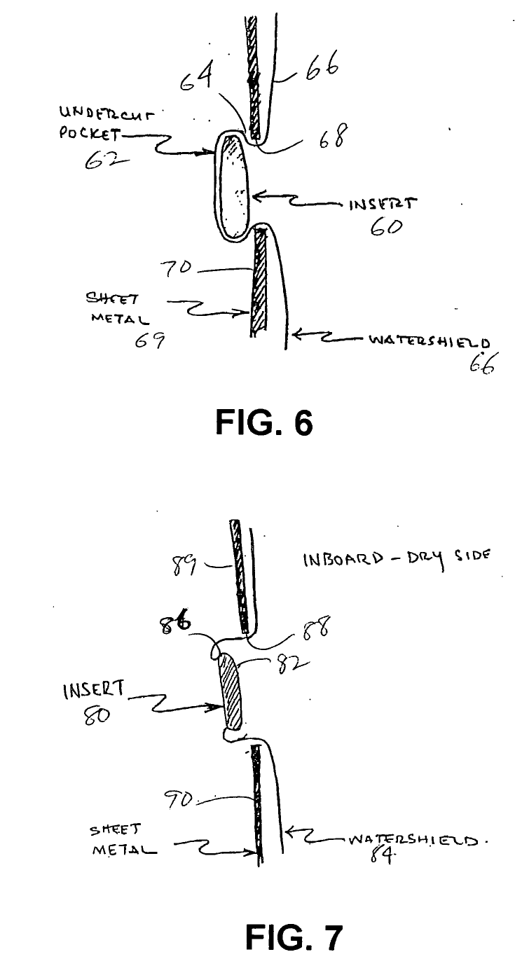

The development may be adapted to snap fit the shield into a hole in sheet metal or other substrate and then to add a material or insert as described above. This isolates and consolidates the use of the expensive sound abatement materials to locations that it is needed, that is, in the holes in the sheet metal. See FIG. 6 for an example of this arrangement. Here, an insert 60 is held in place within a pocket 62 via undercuts 64. The pocket 62 of watershield 66 is snapped into hole 68 of sheet metal 69 of car door 70.

The concept of this development may be adapted to use at the outboard or wet side of a door, lift gate, quarter hole, etc. By incorporating a correctly chose material, the material could be held in place while at the same time allowed to drain freely. Again, these pockets cold be used to hold material and/or hold the part to sheet metal or other substrate as described above. In FIG. 7, an insert 80 is held within pocket 82 of shield 84 via undercuts 86. The pocket 82 is snapped into hole 88 of sheet metal 89 of car door 90.

Finally, the subject snap fit pocket contemplates the development of special tooling and techniques to be used in effectively creating or generating the desired undercut conformations.

The techniques described above were initially formulated to address the issues within an automotive assembly plant. Applications of this technology could be seen in other transportation industries, as well as, but not limited to, appliance and medical. The conformation of the components would replace formed rubber or plastic plugs or other seals.

It will be understood that the above-described embodiments of the invention are for the purpose of illustration only. Additional embodiments, modifications and improvements can be readily anticipated by those skilled in the art, based on a reading and study of the present disclosure. Such additional embodiments, modifications and improvements may be fairly presumed to be within the spirit, scope and purview of the invention.

1. A watershield for use with a vehicle door, comprising:
a wall;
a pocket formed in and extending from said wall;
undercuts formed on opposite ends of said pocket,
wherein said pocket is conformed to be received by an opening in a metal portion of said vehicle door.

2. The watershield of claim 1, wherein each of said undercuts has a smaller inside diameter than an adjacent portion of said pocket.

3. The watershield of claim 1, wherein each of said undercuts accommodates said metal portion of said vehicle door.

4. The watershield of claim 3, wherein said metal portion of said vehicle door comprises sheet metal.

5. The watershield of claim 1, wherein said pocket of said watershield is conformed to be snap fit into said opening in said metal portion of said vehicle door.

6. The watershield of claim 1, wherein said pocket extends through said metal portion of said vehicle door, such that said wall of said watershield is positioned adjacent a first side of said metal portion and said pocket extends through to a second side of said metal portion opposite said first side.

7. The watershield of claim 1, wherein said pocket accommodates an insert surrounded by said undercut of said watershield.

8. The watershield of claim 7, wherein said insert is secured within said pocket via a friction fit.

9. The watershield of claim 8, wherein said insert comprises acoustic material.

10. A watershield and vehicle door assembly comprising:
a watershield comprising:
a wall, and
a pocket extending from said wall;
a vehicle door comprising a metal panel with an opening therethrough, wherein said pocket is selectively received by said opening; and an insert mounted within said pocket of said watershield.

11. The assembly of claim 10, wherein said watershield further comprises an undercut formed on a perimeter of said pocket.

12. The assembly of claim 10, wherein said watershield further comprises an undercut formed on a partial perimeter of said pocket.

13. The assembly of claim 10, wherein said watershield further comprises a plurality of undercuts intermittently spaced around a perimeter of said pocket.

14. The assembly of claim 10, wherein said insert is positioned between said pocket and said metal portion of said vehicle door.

15. The assembly of claim 10, wherein said pocket is positioned between said insert and said metal portion of said vehicle door.

16. A watershield assembly, comprising:
a wall;
a pocket extending from a surface of said wall;
said pocket comprising an undercut on a periphery thereof; and
an attachment which is secured to said wall of said watershield via said undercut of said pocket.

17. The watershield assembly of claim 16, wherein said pocket extends through an opening within said attachment.

18. The watershield assembly of claim 17, wherein said opening within said attachment is centrally positioned within said attachment.

19. The watershield assembly of claim 16, wherein said wall and said pocket are formed of a one-piece conformation.

20. The watershield assembly of claim 16, wherein said undercut comprises an edge which retains said attachment to said wall of said watershield.
